(19) United States
(12) Patent Application Publication
(10) Pub. No.: US 2009/0268841 A1
(43) Pub. Date: Oct. 29, 2009

(54) POWER CONTROL SYSTEM AND METHOD FOR COMMUNICATION SYSTEM USING SPACE-TIME TRANSMIT DIVERSITY SCHEME

(76) Inventors: Byoung-Gi Kim, Daejeon (KR); Kun-Seok Kang, Daejeon (KR); Do-Seob Ahn, Daejeon (KR); Ho-Jin Lee, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/439,329

(22) PCT Filed: Aug. 30, 2007
(86) PCT No.: PCT/KR2007/004178

§ 371 Date: Feb. 27, 2009

(30) Foreign Application Priority Data
Aug. 30, 2006 (KR) 10-2006-0083115

(51) Int. Cl. H04B 7/02; H04L 27/00; H04L 25/49

(52) U.S. Cl. 375/267; 375/295; 375/296; 455/522; 455/69

(57) ABSTRACT

A power control system and method for communication system using space-time transmit diversity scheme. In the power control method, transmission power information of a plurality of antennas or a plurality of subcarriers is monitored. A new space-time code is generated by concatenating the monitored transmission power information and symbols to be transmitted. Symbols encoded using the generated space-time code are generated and the encoded symbols are transmitted. Accordingly, after determining the transmission power of each antenna, the transmission power information is monitored so that the transmission power information that does not experience the channel gain can be used at a next slot. Therefore, the performance degradation due to the round trip time can be reduced, thereby improving the system capacity and performance.

### TECHNICAL FIELD

The present invention relates to a power control system and method for a communication system and, more particularly, to a power control system and method for a satellite or mobile communication system based on multi-user OFDM/WCDMA using a space-time transmit diversity (STTD) scheme.

### BACKGROUND ART

With the advance of communication technology, high-data-rate transmission technology becomes an important issue. In recent years, an Orthogonal Frequency Division Multiplexing (OFDM) scheme is widely used because it is appropriate for high-data-rate transmission over wired/wireless channels. The OFDM scheme transmits data using multi-carriers. Specifically, the OFDM scheme is a multi-carrier modulation (MCM) scheme that parallel-converts a serial symbol stream into parallel symbols and modulates the parallel symbols with a plurality of subcarriers having mutual orthogonality. If the signals are sampled with the subcarriers, interference does not occur although spectra are overlapped with each other. Therefore, intersymbol interference (ISI) does not occur or can be reduced because the subchannels transmit data at a low bit error rate (BER).

Because the OFDM scheme is appropriate for high-data-rate transmission, it was adopted as Institute of Electrical and Electronics Engineers (IEEE) 802.11a and HIPERLAN/2 High-Speed Wireless Local Area Network (LAN) standards, aiming at indoor wireless environment service in U.S.A and Europe, respectively.

The OFDM scheme is also used in a portable Internet service (Wibro) that has been recently issued. The portable Internet service is based on a standard substantially identical to IEEE 802.16 in order for flexibility.

One aim of the third generation (3G) and fourth generation (4G) cellular and satellite systems is to transmit wideband data to users moving at high speed. For example, a real-time multimedia service such as a video conference requires a data rate of about 2-20 Mbps. However, in order to obtain the required data rate, there is a need for new wireless communication systems having a high-efficiency spectrum (bit/sec/Hz) at a limited power. As one method, a space-time transmit diversity and a modulation scheme using multiple transmit antennas were proposed and have been adopted in the third generation mobile communication systems.

In order to provide high-speed and high-quality data services, the next generation mobile communication systems must utilize the spectrum more efficiently and have larger channel capacity. Therefore, the space-time transmit diversity uses a coding scheme obtaining a diversity gain through a plurality of transmit antennas in order to obtain high-speed and high-quality data transmission, higher spectrum efficiency, and higher power efficiency.

However, in the application of the space-time transmit diversity, a Wideband Code Division Multiple Access (WCDMA) mobile communication system uses an open-loop transmit diversity. Therefore, the WCDMA mobile communication system cannot obtain an ideal diversity gain if a transmitter does not perform a perfect channel estimation.

An approach to solving these problems is disclosed in U.S. Pat. No. 6,977,910, entitled “POWER CONTROL WITH SPACE TIME TRANSMIT DIVERSITY.” This patent provides a power control system that can obtain an ideal diversity gain in a WCDMA mobile communication system using a closed-loop space-time transmit diversity scheme.

However, the power control apparatus and method disclosed in the patent can be applied only to a mobile communication system. If the conventional power control system is applied to a satellite communication system, the satellite communication system becomes very inefficient due to round trip time. Furthermore, when the space-time transmit diversity scheme is applied, an additional pilot bit known by both the transmitter and the receiver is required. This is very inefficiency in view of high-efficiency bandwidth management.

Moreover, in order for power control when the space-time transmit diversity scheme is applied to the OFDM mobile communication system, the receiver must performs a perfect channel estimation, just like in the WCDMA mobile communication system.

An approach to solving these problems is disclosed in a paper, entitled “IMPROVED POWER ALLOCATION SCHEMES BASED ON STBC-OFDM IN FREQUENCY SELECTIVE FADING CHANNEL”, IEEE International Conference on Communication Technology (ICCT) Proceedings, April 2003, vol. 2, pp. 1042-1045. This paper proposes three algorithms efficient for an STBC-OFDM: a power algorithm for each antenna, a power algorithm for each subcarrier, and a power algorithm for each antenna and each subcarrier.

However, the algorithms disclosed in this paper can be applied only to a mobile communication system, just like in the above-described patent. In addition, in the simulation environment, the algorithms can be applied only when the channel estimation is perfect. Moreover, an additional power control apparatus and an additional power bit are required.

### DISCLOSURE OF INVENTION

### Technical Problem

The present invention has been made to solve the foregoing problems of the prior art and therefore an aspect of the present invention is to provide a power control system and method that can increase a data rate and a system capacity by applying a space-time transmit diversity in a satellite/mobile communication system based on multi-user OFDM/WCDMA.

Another aspect of the invention is to provide a power control system and method that can transmit data without using additional bandwidth for transmitting pilot bit known by both the transmitter and the receiver when a space-time transmit diversity scheme is applied to a WCDMA satellite/mobile communication system.

A further aspect of the present invention is to provide a power control system that provide a new space-time code generator without additional data bit for allocating power to each antenna or each subcarrier when a space-time transit diversity is applied to an OFDM satellite/mobile communication system.

### Technical Solution

According to an embodiment of the invention, a power control method in a transmitter of a communication system using a space-time transmit diversity scheme includes: monitoring transmission power information of a plurality of antennas or a plurality of subcarriers; generating a new space-time code by concatenating the monitored transmission power information and symbols to be transmitted; and RF-processing symbols encoded using the generated space-time code and transmitting the encoded symbols.

According to another embodiment of the present invention, a power control method in a receiver of a communication system using a space-time transmit diversity scheme includes: RF-processing symbols encoded using a new space-time code, the new space-time code being generated using transmission power information monitored from a transmitter; extracting transmission symbols at each antenna of the transmitter by space-time-decoding the RF-processed symbols; estimating power of the respective extracted symbols; and transmitting feedback information of the respective symbols to the transmitter.

According to a further embodiment of the present invention, a power control system of a communication system using a space-time transmit diversity scheme includes: a transmission power calculator for updating transmission power information using feedback information received from a receiver and adjusting the updated transmission power information; a transmission power monitor for monitoring the adjusted transmission power information; a space-time encoder newly generated for performing a space-time encoding by concatenating the monitored transmission power information and symbols to be transmitted; and an RF processor for RF-processing the encoded symbols.

According to a further embodiment of the present invention, a power control system of a communication system using a space-time transmit diversity scheme includes: an RF processor for RF-processing symbols encoded by a space-time encoder, the space-time encoder being newly generated using transmission power information monitored from a transmitter, and estimating reception power and interference of the respective symbols extracted at respective antennas of the transmitter; a space-time decoder for extracting transmission symbols at the respective antennas of the transmitter by space-time decoding the RF-processed symbols; a channel estimator for detecting channel information corresponding to the respective antennas; and a feedback channel for transmitting feedback information corresponding to the respective symbols to the transmitter.

### Advantageous Effects

In the satellite/mobile communication system using the space-time transmit diversity scheme according to the exemplary embodiments of the present invention, the existing open-loop transmit diversity is modified into a closed-loop transmit diversity using the subcarrier power and phase information in each antenna, thereby improving the system capacity and performance.

In addition, after determining the transmission power of each antenna, the transmission power information is monitored so that the transmission power information that does not experience the channel gain can be used at a next slot. Therefore, the performance degradation due to the round trip time (the time necessary for feedback from the satellite communication system to the satellite/base station) can be reduced. In the case of the OFDM system, the phase or power information can be provided without additional bandwidth.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a transmitter of an OFDM communication system using a space-time transmit diversity scheme according to an embodiment of the present invention;

FIG. 2 is a block diagram of a receiver of an OFDM communication system using a space-time transmit diversity scheme according to an embodiment of the present invention;

FIG. 3 is a block diagram of a transmitter of a WCDMA communication system using a space-time transmit diversity scheme according to an embodiment of the present invention;

FIG. 4 is a block diagram of a receiver of a WCDMA communication system using a space-time transmit diversity scheme according to an embodiment of the present invention;

FIG. 5 is a flow diagram illustrating a transmitting procedure for power control in a communication system using a space-time transmit diversity scheme according to an embodiment of the present invention;

FIG. 6 is a flow diagram illustrating a receiving procedure for power control in a communication system using a space-time transmit diversity according to an embodiment of the present invention;

FIG. 7 is a block diagram illustrating an uplink/downlink operation of a communication system using a space-time transmit diversity scheme according to an embodiment of the present invention;

FIG. 8 is a graph illustrating a symbol error rate, a bit error rate, and a frame error rate with respect to a receive Eb/NO of an OFDM in a terrestrial environment according to an embodiment of the present invention; and

FIG. 9 is a graph illustrating a symbol error rate, a bit error rate, and a frame error rate with respect to a receive Eb/NO of an OFDM in a satellite communication environment according to an embodiment of the present invention.

### BEST MODE FOR CARRYING OUT THE INVENTION

Exemplary embodiments of the present invention will now be described in detail with reference to the accompanying drawings. Like reference numerals are used to refer to like elements throughout the drawings. In the following description, wellknown functions or constructions are not described in detail since they would obscure the invention in unnecessary detail.

In the embodiments of the present invention, an OFDM/WCDMA satellite/mobile communication system using a space-time transmit diversity scheme will be described only for illustrative purposes. Hereinafter, as a power control system for the OFDM/WCDMA satellite/mobile communication system, a transmitter and a receiver will be described in detail with reference to the accompanying drawings.

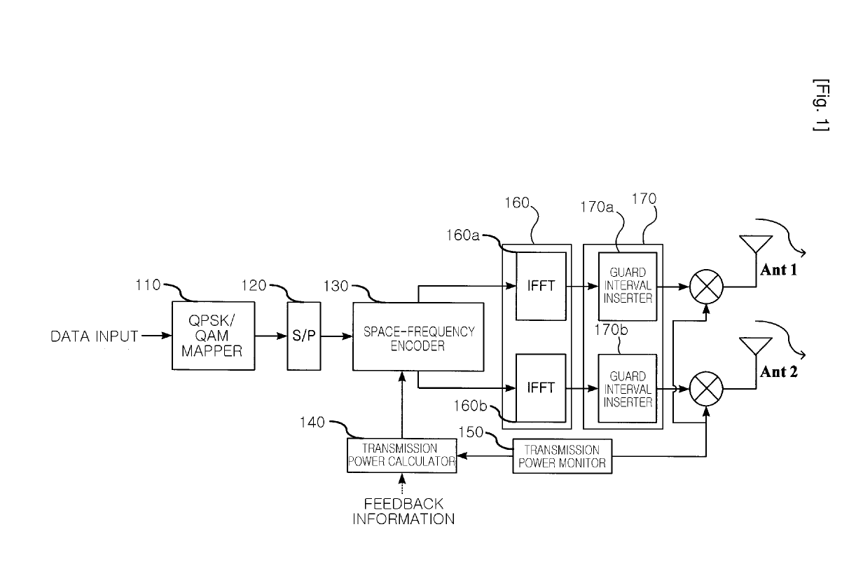

FIG. 1 is a block diagram of a transmitter of an OFDM communication system using a space-time transmit diversity scheme according to an embodiment of the present invention.

Referring to FIG. 1, the transmitter 100 of the OFDM communication system includes a QPSK/QAM mapper 110, a serial-to-parallel (S/P) converter 120, a space-frequency encoder 130, a transmission power calculator 140, a transmission power monitor 150, and a plurality of inverse fast Fourier transform (IFFT) processors 160, a plurality of guard interval inserters 170, and a plurality of multipliers, and a plurality of antennas.

The QPSK/QAM mapper 110 modulates input data in accordance with a pre-determined modulation scheme and outputs modulation symbols. The input data represents data that is encoded at a predetermined code rate and then is interleaved. Examples of the modulation scheme include 8-ary phase shift keying (8PSK), 16-ary quadrature amplitude modulation (16QAM), and quadrature phase shift keying (QPSK).

The S/P converter 120 parallel-converts the serial modulation symbols output from the QPSK/QAM mapper 110 into parallel signals.

The space-frequency encoder 130 generates new space-frequency codes by concatenating a feedback information received from a receiver, a transmission power value calculated by the transmission power calculator 140, and a data symbol output from the S/P converter 120.

The transmission power calculator 140 calculates the transmission power using the feedback information received from a receiver and the monitoring transmit power information of a corresponding antenna or a corresponding subcarrier, which is monitored by the transmission power monitor 150.

The IFFT processor 160 performs an IFFT operation on the space-frequency codes output from the space-frequency encoder 130 and outputs OFDM symbols.

The guard interval inserter 170 inserts guard intervals between the OFDM symbols output from the IFFT processor 160, that is, successive blocks. The guard interval is inserted in order to prevent the interference between the current OFDM symbol and the previous symbol while the OFDM symbol is transmitted over multipath channel.

The multiplier 180 RF-processes the OFDM symbols output from the guard interval inserter 170, multiplies the transmission power corresponding to the symbol, and transmits the resulting signal through the antenna over satellite/terrestrial channel.

A structure of an OFDM receiver processing the signals outputted from the OFDM transmitter will be described below.

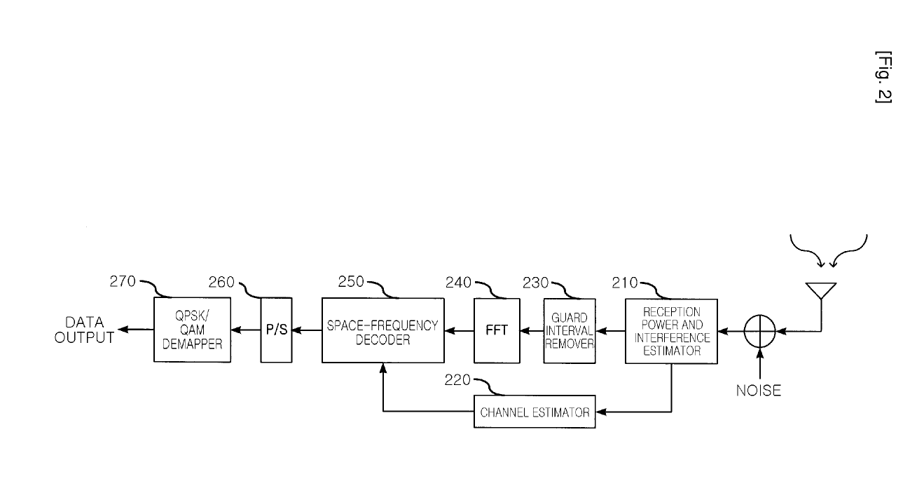

FIG. 2 is a block diagram of an OFDM receiver using a space-time transmit diversity scheme according to an embodiment of the present invention.

Referring to FIG. 2, the OFDM receiver 200 includes an RF processing part, a channel estimator 220, a space-frequency decoder 250, a parallel-to-serial (P/S) converter 260, a guard interval remover 230, and a QPSK/QAM demapper 270. The RF processing part includes an antenna, a summer, a reception power and interference estimator 210, and an FFT converter 240.

The reception power and interference processor 210 estimates reception power and interference in order to control power of incoming signals after removing noise from the signal received by the antenna through the accumulator.

The channel estimator 220 estimates a channel from the symbol output from the reception power and interference estimator 210, and transmits information about the estimated channel to the decoder 250.

The guard interval remover 230 removes the guard interval from the symbols output from the reception power and interference estimator 220.

The FFT processor 240 FFT-processes the OFDM symbols from which the guard interval is removed by the guard interval remover 230.

The space-frequency decoder 250 performs a space-frequency decoding operation by combining the information about the estimated channel and the signal output from the FFT processor 240.

The P/S converter 260 converts the decoded parallel signals into serial signals, i.e., successive symbols.

The demapper 270 may use QPSK/QAM scheme. The demapper 270 demodulates the converted successive symbols in accordance with a demodulation scheme corresponding to the modulation scheme applied at the transmitter and then outputs encoded bits, i.e., data.

Hereinafter, a transmitter of a WCDMA satellite/mobile communication system using a space-time transmit diversity scheme according to an embodiment of the present invention will be described below in detail. A structure of a WCDMA transmitter will be first described below with reference to the accompanying drawings.

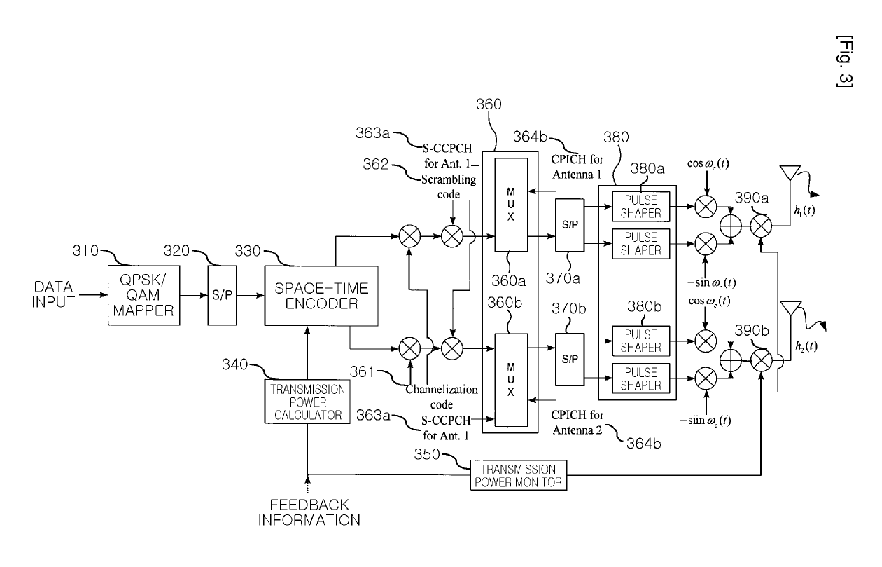

FIG. 3 is a block diagram of a transmitter of a WCDMA communication system using a space-time transmit diversity scheme according to an embodiment of the present invention.

Referring to FIG. 3, the transmitter includes a mapper 310, a first S/P converter 320, a space-time encoder 330, a transmission power calculator 340, a transmission power monitor 350, a multiplexer 360, a second S/P converter 370, a pulse shaper 380, and an RF processor. The RF processor includes a plurality of multipliers and a plurality of antennas.

The mapper 310 is a QPSK/QAM mapper. The mapper 310 modulates input data in accordance with a QPSK/QAM modulation scheme and outputs modulation symbols.

The S/P converter 320 parallel-converts the modulation symbols into successive parallel signals.

The space-time encoder 330 generates space-time codes by concatenating information about transmission power calculated by the transmission power calculator 340 with data symbols output from the S/P converter 320.

The transmission power calculator 340 calculates the transmission power using the feedback information received from the receiver and the transmission power information of the corresponding antenna or subcarrier, which is monitored by the transmission power monitor 350.

Unlike the OFDM satellite/mobile communication system, the transmitter of the WCDMA communication system need not generate new space-time codes because physical layer channels, secondary common control physical channel (S-CCPCH) and common pilot channel (CPICH), exist in additional transmission power and phase information of the WCDMA.

The plurality of multipliers are connected between the space-time encoder 330 and the multiplexer. The first multipliers directly connected to the space-time encoder 330 multiply the space-time encoded signals by channelization code 361 identifying users. The second multipliers connected to the first multipliers the signals output from the first multipliers by scrambling code 362 identifying base stations.

The multiplexer 360 multiplexes the CHICH and the S-CCPCH in order to provide the transmission power and phase information of each antenna. The CHICH channel does not perform the power control operation, while the S-CCPCH experiences the power control operation.

The pulse shaper 380 performs a pulse shaping operation with a roll-off factor of 0.22. The multipliers connected to the pulse shaper 380 multiply the signals output from the pulse shaper 380 by the respective phase signals cos wc(t) and −sin wc(t). The resulting signals are again added and output to the multipliers 390a and 390b connected to the antennas.

The multipliers 390a and 390b multiply the added signals by transmission power weight calculated by the transmission power calculator 350 and output the resulting signals through the corresponding antennas.

A structure of a WCDMA receiver processing the signals received from the WCDMA transmitter will be described below with reference to the accompanying drawings.

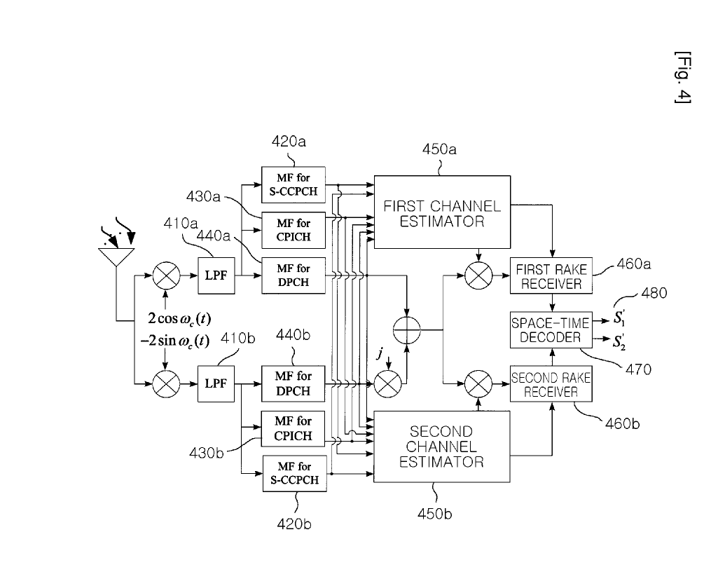

FIG. 4 is a block diagram of a receiver of a WCDMA communication system using a space-time transmit diversity scheme according to an embodiment of the present invention.

Referring to FIG. 4, the receiver includes an RF processor, a plurality of channel matching filters 420a, 420b, 430a, 430b, 440a and 440b, and channel estimators 450a and 450b, rake receivers 460a and 460b, and a space-time decoder 470. The RF processor includes a plurality of multipliers, a plurality of antennas, and a plurality of low pass filters (LPF) 410a and 410b.

The receiver receives a plurality of signals from the transmitter through the antennas. The multipliers connected to the antennas multiply the received signals by phase signals 2 cos wc(t) and 2 sin wc(t) and output the resulting signals to the low pass filters 410a and 410b.

The low pass filters 410a and 410b low-pass-filters the received signals to output baseband signals.

The channel matching filters 420a, 420b, 430a, 430b, 440a and 440b are provided for S-CCPCH, CPICH, and DPCH. The channel matching filters 420a and 420b detect the S-CCPCH transmitted through the antennas, and the channel matching filters 430a and 430b detect the CPICH. The channel matching filters 440a and 440b detect the dedicated physical channel (DPCH). The channel matching filters 440a and 440b are connected to the summer. The summer adds the matching filtered signals for the DPCH.

In order to increase the reception SIR, the channel estimators 450a and 450b outputs a combination of data channel, the S-CCPCH, and the CPICH and extracts the channel information of each antenna. The extracted channel information is inputted to the rake receivers 460a and 460b. The channel information of each antenna is transmitted to the satellite/base station over the feedback channel.

The first rake receiver 460a detects the received signal by performing a conjugate operation on the output value of the channel information 450 of the first antenna, and the second rake receiver 460b detects the received signal by performing a conjugate operation on the output value of the channel information of the second antenna.

The space-time decoder 470 detects desired reception symbols S′1 and S′2 by space-time-decoding the detected signals (the channel information).

Hereinafter, a power control method in the transmitter/receiver of the OFDM/WCDMA communication system using the space-time transmit diversity scheme will be described in detail. The power control method of the transmitter will be first described below with reference to the accompanying drawings. The OFDM satellite/mobile communication system will be described for illustrative purposes.

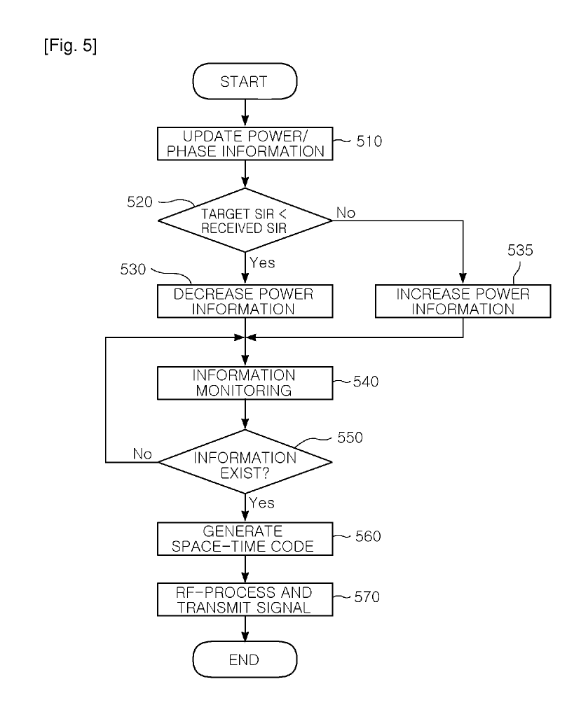

FIG. 5 is a flow diagram illustrating a transmitting procedure for power control in a communication system using a space-time transmit diversity scheme according to an embodiment of the present invention.

Referring to FIG. 5, the transmitter updates power/phase information in step 510 and compares a target SIR and a received SIR. When the target SIR is less than the received SIR, the transmitter decreases the power information in step 530. On the other hand, when the target SIR is greater than the received SIR, the transmitter increases the power information in step 535.

Then, the transmitter monitors the information fed back from the receiver in step 540 and determines if the monitored feedback information exists in step 550. When the monitored feedback information does not exist, the process returns to step 550. On the other hand, when the monitored feedback information exists, the transmitter transmits the feedback information to the space-time encoder through the transmission power calculator. In step 560, the transmitter generates a new space-time code by concatenating the symbol information output from the S/P converter, the feedback information, and the monitored transmission power information of the corresponding antenna and subcarrier.

In step 570, the transmitter RF-processes the symbol containing the generated space-time code, i.e., the output signal of the space-time encoder, and multiplies the RF-processed signal by the transmission power of the symbol, and transmits the resulting signal through the antenna over the satellite/terrestrial channel. In the case of the OFDM communication system, the transmitter performs the RF process after the IFFT operation and the insertion of the guard interval. In the case of the WCDMA communication system, the transmitter performs the RF process after the multiplexing.

The power control procedure will be described below in more detail.

At the transmitter, an initial transmission symbol vector is expressed as Equation (1) below.

$$\begin{matrix}\begin{matrix}{X}_{n} = diag [ \begin{matrix}{X}_{n} ( 0 ) , {X}_{n} ( 1 ) , … , \\ {X}_{n} ( {N}_{c} - 1 )\end{matrix} ] \\ = [ \begin{matrix}{X}_{n} ( 0 ) & … & 0 \\ ⋮ & ⋱ & ⋮ \\ 0 & … & {X}_{n} ( 0 )\end{matrix} ] \\ = [ \begin{matrix}1 & … & 0 \\ ⋮ & ⋱ & ⋮ \\ 0 & … & 1\end{matrix} ] [ \begin{matrix}{X}_{n} ( 0 ) \\ ⋮ \\ {X}_{n} ( {N}_{c} - 1 )\end{matrix} ]\end{matrix} & Equation ( 1 )\end{matrix}$$

where diag[.] represents an n×n matrix in which the diagonal elements are nonzero and the off-diagonal elements are zero, Xₙ(0) represents an n^{th} OFDM symbol mapped on a 0^{th} subcarrier, and N_{c} represents the number of subcarriers.

When the transmission power and phase information is monitored in step 540, no information exists in an initial state. Thus, the generation of the space-time code is identical to that in the existing system. However, when the transmission power information monitored after the initial state exists, the new space-time code is generated as expressed in Equation (2) below.

$$\begin{matrix}\begin{matrix}{\overline{X}}_{n} = [ \begin{matrix}{X}_{n} & \overline{W}\end{matrix} ] \\ = [ \begin{matrix}1 & … & 0 & {W}_{1}^{0} \\ ⋮ & ⋱ & ⋮ & ⋮ \\ 0 & ⋱ & 1 & {W}_{1}^{N - 1} \\ 0 & … & 1 & {W}_{1}^{N}\end{matrix} ] [ \begin{matrix}{X}_{n} ( 0 ) \\ ⋮ \\ {X}_{n} ( {N}_{c} - 1 ) \\ {X}_{n} ( {N}_{c} )\end{matrix} ] \\ = [ \begin{matrix}{X}_{n} ( 0 ) + {W}_{1}^{0} {X}_{n} ( {N}_{c} ) \\ {X}_{n} ( 1 ) + {W}_{1}^{1} {X}_{n} ( {N}_{c} ) \\ ⋮ \\ {X}_{n} ( {N}_{c} - 1 ) + {W}_{1}^{N} {X}_{n} ( {N}_{c} )\end{matrix} ]\end{matrix} & Equation ( 2 )\end{matrix}$$

In Equation (2), a normalized sum of all weights of an i^{th} transmission power (a total sum of the monitored transmission power information) is equal to

$${\sum }_{k = 0}^{{N}_{c} - 1} {W}_{i}^{k} = 1.$$

After generating the new space-time code in step 560, the transmitter performs an OFDM transmitting procedure using Equation (3) in step 570.

$$\frac{{E}_{s}}{2} [ \begin{matrix}{A}_{n}^{1} & {A}_{n}^{2} \\ {A}_{n + 1}^{1} & {A}_{n + 1}^{2}\end{matrix} ] = \frac{{E}_{s}}{2} [ \begin{matrix}{\overline{X}}_{n} & {\overline{X}}_{n + 1} \\ - {\overline{X}}_{n + 1}^{*} & {\overline{X}}_{n}^{*}\end{matrix} ] \qquad Equation ( 3 )$$

where Eₛ represents the transmission energy per symbol in each subcarrier, Aₙⁱ represents the transmission of an n^{th} OFDM symbol at an i^{th} transmission antenna, and * represents a conjugate.

In this way, the OFDM symbols transmitted through the respective antennas of the transmitter are transmitted to the receiver having a single receive antenna through satellite/terrestrial channel. A power control method of the receiver will be described below in detail with reference to the accompanying drawings.

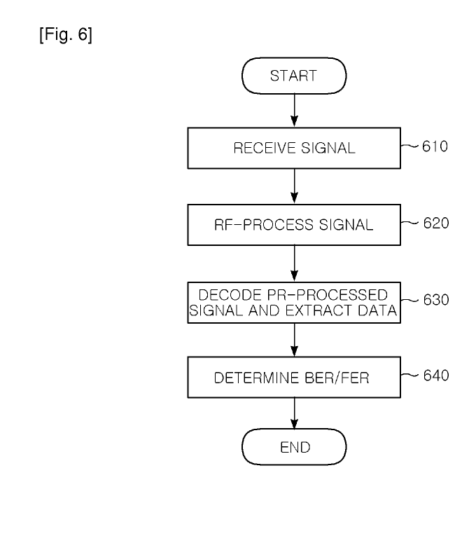

FIG. 6 is a flow diagram illustrating a receiving procedure for power control in a communication system using a space-time transmit diversity according to an embodiment of the present invention.

Referring to FIG. 6, the receiver receives the signal transmitted from the transmitter in step 610. The received signal is expressed as Equation (4).

$$[ \begin{matrix}{R}_{n}^{1} \\ {R}_{n + 1}^{1}\end{matrix} ] = \sqrt{\frac{{E}_{s}}{2}} [ \begin{matrix}{{X}^{ \_}}_{n} & {{X}^{ \_}}_{n + 1} \\ - {\overline{X}}_{n + 1}^{*} & {\overline{X}}_{n}^{*}\end{matrix} ] [ \begin{matrix}{\overline{H}}_{1} \\ {\overline{H}}_{2}\end{matrix} ] + [ \begin{matrix}{N}_{1} \\ {N}_{2}\end{matrix} ] \qquad Equation ( 4 )$$

where Rₙⁱ represents a reception of an n^{th} OFDM symbol at an i^{th} receive antenna, Hᵢ represents a channel gain experienced at the i^{th} transmit antenna, and Nᵢ represents a Gaussian noise during an i^{th} OFDM symbol period.

The receiver RF-processes the received signal in step 620. That is, the receiver performs the inverse OFDM operation. Specifically, the receiver estimates the reception power and interference from the received signal, removes the inserted guard interval, FFT-processes the resulting signal where the guard interval is removed, and outputs the FFT-processed signal to the encoder.

In step 630, the receiver estimates the channel using the estimated reception power, and decodes the successive signals through the space-time encoder using the estimated channel information. At this point, the receiver converts the serial decoded signal into parallel signals and extracts data by decoding the parallel signals using the modulation scheme applied at the transmitter. The estimation of the transmission symbol can be expressed as Equation (5) below.

$$[ \begin{matrix}{{X}^{\hat{ \_}}}_{n} \\ {{X}^{\hat{ \_}}}_{n + 1}\end{matrix} ] = [ \begin{matrix}\sqrt{\frac{{E}_{s}}{2}} ( {\vert {\overline{H}}_{1} \vert}^{2} + {\vert {\overline{H}}_{2} \vert}^{2} ) {\overline{X}}_{n} + {N}_{1}^{T} {\overline{H}}_{1}^{*} + {N}_{2}^{H} {\overline{H}}_{2} \\ \sqrt{\frac{{E}_{s}}{2}} ( {\vert {\overline{H}}_{1} \vert}^{2} + {\vert {\overline{H}}_{2} \vert}^{2} ) {\overline{X}}_{n + 1} + {N}_{1}^{T} {\overline{H}}_{2}^{*} - {N}_{2}^{H} {\overline{H}}_{1}\end{matrix} ] \qquad Equation ( 5 )$$

where T represents a transpose operation of an arbitrary matrix, and H represents a conjugate (*) operation after the transpose operation.

After extracting the symbols transmitted through the respective antennas, the receiver determines a bit error rate (BER) or a frame error rate (FER) in step 640. Information about the determined bit/frame error rate and SNR information of each subcarrier are transmitted as the feedback information through the feedback channel to the transmitter. The SNR for each subcarrier is expressed as Equation (6) below.

$$W = \frac{S}{N} ( i , k ) = \frac{{E}_{s}}{2 {N}_{0}} ( {\vert {H}_{1} ( i , k ) \vert}^{2} + {\vert {H}_{2} ( i , k ) \vert}^{2} ) \qquad Equation ( 6 )$$

where Hⱼ(i,k) represents a channel gain experienced at a k^{th} subcarrier of an i^{th} transmit antenna for a j^{th} user, and N₀ represents a noise power density.

Meanwhile, the SNR information, i.e., the feedback information transmitted from the receiver is inputted to the transmitter. Then, the transmitter updates the transmission power like in step 510 of FIG. 5.

During the updating of the power and phase information, the transmission power information is updated using Equation (7) below by concatenating the information W̅

about the transmission power monitored using Equation (2) and the feedback information W received from the receiver.

P_{i,rec}(n)=P_{i,int}(n)+ W̅(i,n)−W(i,n−RTD) Equation (7)

where P_{i,int}(n) represents the initial transmission power of the i^{th} user, P_{i,rec}(n) represents the power received by the i^{th} user during the n^{th} OFDM symbol period, W̅(i,n)

represents the monitoring information about the product of each subcarrier and weight during the n^{th} OFDM symbol period of the i^{th} user, and W(i,n−RTD) represents the information when the receiver receives the information about the product of each subcarrier and the weight after the round trip delay (RTD).

Through these processes, the degradation of the system performance due to the time delay can be perfectly prevented.

Then, the power can be controlled in each subcarrier by comparing the required SIR with the received SIR. The ith received SIR is expressed as Equation (8) below.

$${SIR}_{i , rec} = \frac{{P}_{i , rec}}{{∀}_{i \neq i all user} {P}_{i , rec}} \qquad Equation ( 8 )$$

In steps 520 and 530 of FIG. 5, the transmitter compares the received SIR information obtained using Equation (9) and the target SIR information of each subcarrier. When the received SIR is less than the target SIR, the power information increases and the corresponding subcarrier transmission power information is transmitted. On the other hand, when the received SIR is greater than the target SIR, the power information decreases and the corresponding subcarrier transmission power information is transmitted.

Although the OFDM system has been described for illustrative purposes, the WCDMA can control the power through the processes described with reference to FIGS. 5 and 6. In the case of the WCDMA system, the channel estimation value is obtained using the receive channels (CPICH, S-CCPCH) and the data channel, and the transmission symbols are detected through the new space-time code generated from the signals transmitted through the antennas of the receiver. The new space-time code can be generated as shown in FIG. 5.

Hereinafter, a power control using an uplink/downlink operation of the satellite/mobile communication system will be described below in detail.

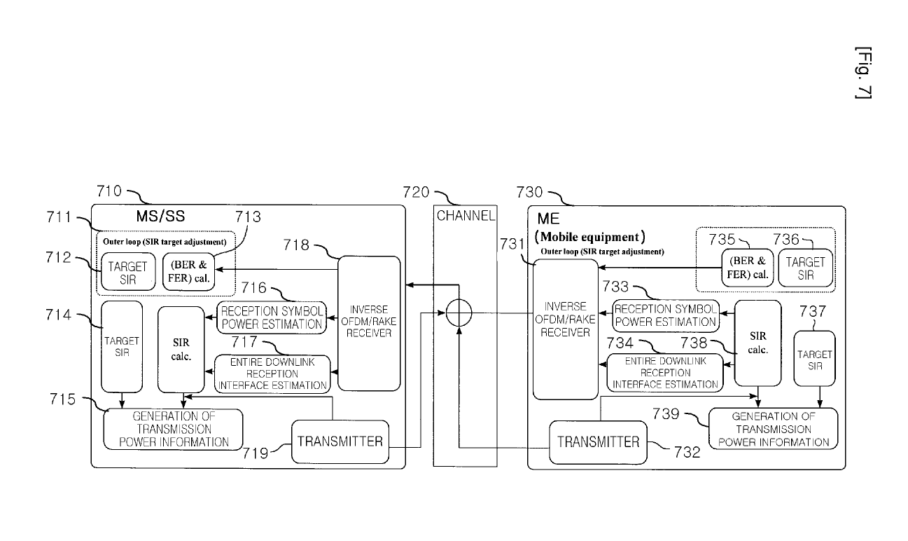

FIG. 7 is a block diagram illustrating an uplink/downlink operation of a communication system using a space-time transmit diversity scheme according to an embodiment of the present invention.

Referring to FIG. 7, the satellite/mobile communication system according to the present invention can perform the bi-directional power control.

When a satellite or base station 710 sets an initial transmission power level to 1 dB or 2 dB, the information about the set transmission power level is transmitted to mobile equipment (ME) 730 over a channel 720. A transmitter 719 of the satellite/base station 710 monitors the initial transmission power level and transmits information which does not experience the channel 720 so as to generate information for transmission power of next slot (715).

Then, the mobile equipment 730 receives the information about the transmission power level through a rake receiver 631 and estimates reception symbol power (733). The mobile equipment 730 extracts the entire downlink reception interference components (734) and calculates the received SIR (738). In an outer loop, the reception symbols are detected and BER/FER are calculated (735), and the target SIR is determined (736).

The mobile equipment 730 estimates the determined target SIR (737) and generates the transmission power information by comparing the estimated target SIR and the received SIR (737). The transmission power information is generated at a next slot (739), and the generated transmission power information is directly used in the next slot as a value that does not experience the channel so as to compensate for the round trip time with respect to the satellite/base station 710.

As illustrated in FIG. 3, when the WCDMA transmitter estimates the reception symbol power (733) and the entire downlink reception interference components, pilot symbols of S-CCPCH and CPICH are used. Specifically, when the channel or the reception signal interference is estimated using the pilot symbol in WCDMA standard, the pilot symbols known by both the transmitter and the receiver is periodically time-division-multiplexed with data symbols. The channel variation of the data symbol period is compensated using the channel estimation value of the pilot symbol period. That is, using only the pilot symbols of the DPCCH, the channel is estimated and the interference of the received signal is measured. As another method, the data symbols are compensated and the interference is measured with respect to the channel variation by transmitting the pilot symbols known by both the transmitter and the receiver using the predefined pilot symbol patterns. That is, using only the CPICH, the channel is estimated and the interference of the received signal is measured.

Therefore, the problems of the existing independent channel estimation/received signal interference method can be solved by combining the two methods and introducing the pilot symbols of the S-CCPCH. Consequently, the channel estimation and the received signal interference estimation can be achieved more correctly. In the existing independent channel estimation/received signal interference method, if the channel for the channel estimation experiences a deep fading, more errors occur even though the channel estimation is achieved.

A reason for performing such a channel estimation is that an additional pilot diversity can be implemented. Another reason is that the internal stability and network stability can be improved when the next slot transmission power is determined using the information that does not experience the channel during the process of monitoring the transmission power information in order to compensate for the round trip time.

FIG. 7 shows how much better the system performance is improved in using the OFDM system using the space-time transmit diversity scheme in a Rayleigh fading channel environment in the above-described embodiments of the present invention.

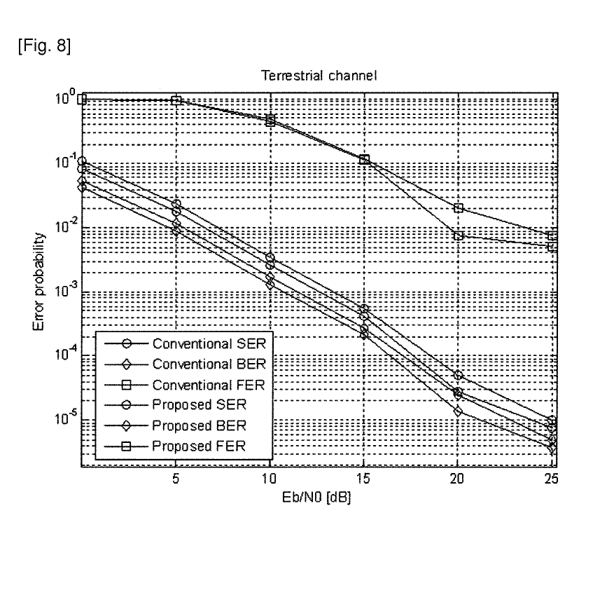

FIG. 8 is a graph illustrating a computer simulation result. 8-tap FIR filter channel was used and each tap had independent Rayleigh fading. In a BER 10-3 satisfying voice service, the receive Eb/NO of the existing system is 11.5 dB, and the receive Eb/NO in the embodiment of the present invention is 10.7 dB. Further, since the embodiments of the present invention adopt the round trip time compensation algorithm, the existing system that does not adopt the round trip time compensation algorithm satisfies the voice service environment at a higher receive Eb/NO.

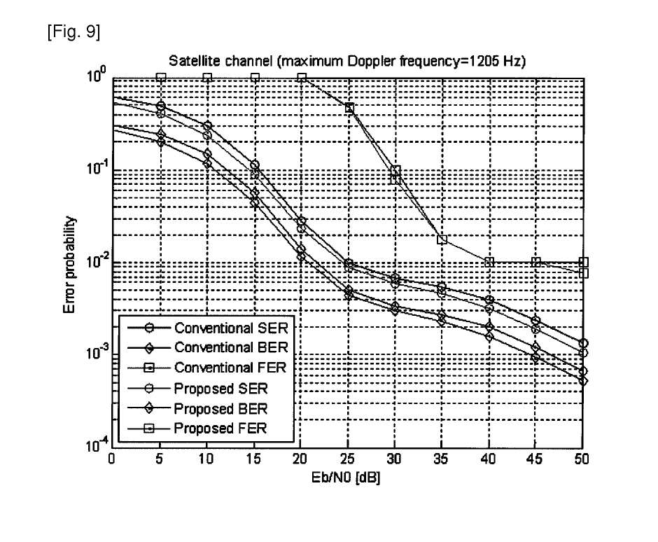

A satellite channel impulse model performs a computer simulation with reference to a paper entitled SATELLITE DOWNLINK RECEPTION THROUGH INTERMEDIATE MODULE REPEATERS: POWER DELAY PROFILE ANALYSIS, Mobile Application & sErvices bases on Satellite & Terrestrial inteRwOrking (MAESTRO), 2004. Oct. 28, 2004. The results are given as shown in FIG. 9. As computer simulation parameters, a carrier frequency is 2,170 MHz and a rice factor is 0 dB. Since the round trip time compensation algorithm is equally adopted in the existing system, the existing system that does not adopt the round trip time compensation algorithm satisfies the voice service environment at a higher receive Eb/NO.

In the satellite/mobile communication system using the space-time transmit diversity scheme according to the exemplary embodiments of the present invention, the existing open-loop transmit diversity is modified into a closed-loop transmit diversity using the subcarrier power and phase information in each antenna, thereby improving the system capacity and performance.

In addition, after determining the transmission power of each antenna, the transmission power information is monitored so that the transmission power information that does not experience the channel gain can be used at a next slot. Therefore, the performance degradation due to the round trip time (the time necessary for feedback from the satellite communication system to the satellite/base station) can be reduced. In the case of the OFDM system, the phase or power information can be provided without additional bandwidth.

While the present invention has been shown and described in connection with the preferred embodiments, it will be apparent to those skilled in the art that modifications and variations can be made without departing from the spirit and scope of the invention as defined by the appended claims.

1. A power control method in a transmitter of a communication system using a space-time transmit diversity scheme, comprising:
monitoring transmission power information of a plurality of antennas or a plurality of subcarriers;
generating a new space-time code by concatenating the monitored transmission power information and symbols to be transmitted; and
RF-processing symbols encoded using the generated space-time code and transmitting the encoded symbols.

2. The power control method according to claim 1, further comprising:
updating the transmission power information by concatenating the monitored transmission power information and feedback information received from a receiver; and
adjusting the transmission power information using signal-to-noise ratio (SNR).

3. The power control method according to claim 2, wherein the adjusting of the transmission power information comprises:
comparing a received signal-to-interference ratio (SIR) and a required SIR;
decreasing the transmission power information when the received SIR is greater than the required SIR; and
increasing the transmission power information when the required SIR is greater than the received SIR.

4. The power control method according to claim 2, wherein the transmission power information is applied before a next slot and is calculated using a following equation by concatenating information ( W̅(n)) monitored before a round trip time between the transmitter and the receiver and the feedback information (W(n−RTD)) received from the receiver
P_{i,rec}(n)=P_{i,int}(n)+ W̅(i,n)−W(i,n−RTD)
where P_{i,int}(n) represents an initial transmission power of an i^{th} user, and P_{i,rec}(n) represents a power received by the i^{th} user during an n^{th} OFDM symbol period.

5. The power control method according to claim 1, wherein when the transmission power information exists after an initial monitoring, the new space-time code is generated using a following equation
$$\begin{matrix}{\overline{X}}_{n} = [ \begin{matrix}{X}_{n} & \overline{W}\end{matrix} ] \\ = [ \begin{matrix}1 & … & 0 & {W}_{1}^{0} \\ ⋮ & ⋱ & ⋮ & ⋮ \\ 0 & ⋱ & 1 & {W}_{1}^{N - 1} \\ 0 & … & 1 & {W}_{1}^{N}\end{matrix} ] [ \begin{matrix}{X}_{n} ( 0 ) \\ ⋮ \\ {X}_{n} ( {N}_{c} - 1 ) \\ {X}_{n} ( {N}_{c} )\end{matrix} ] [ \begin{matrix}{X}_{n} ( 0 ) + {W}_{1}^{0} {X}_{n} ( {N}_{c} ) \\ {X}_{n} ( 1 ) + {W}_{1}^{1} {X}_{n} ( {N}_{c} ) \\ ⋮ \\ {X}_{n} ( {N}_{c} - 1 ) + {W}_{1}^{N} {X}_{n} ( {N}_{c} )\end{matrix} ]\end{matrix}$$
where
W̅
represents the monitored transmission power information, Xn represents the symbols to be transmitted, and Nc represents number of subcarriers.

6. The power control method according to claim 1, wherein the RF-processed symbols are transmitted using a following equation
$$\frac{{E}_{s}}{2} [ \begin{matrix}{A}_{n}^{1} & {A}_{n}^{2} \\ {A}_{n + 1}^{1} & {A}_{n + 1}^{2}\end{matrix} ] = \frac{{E}_{s}}{2} [ \begin{matrix}{{X}^{ \_}}_{n} & {{X}^{ \_}}_{n + 1} \\ - {\overline{X}}_{n + 1}^{*} & {\overline{X}}_{n}^{*}\end{matrix} ]$$
where Es represents a transmission energy per symbol in each subcarrier, Aₙⁱ represents a transmission of an n^{th} OFDM symbol at an i^{th} transmission antenna, and * represents a conjugate.

7. A power control method in a receiver of a communication system using a space-time transmit diversity scheme, comprising:
RF-processing symbols encoded using a new space-time code, the new space-time code being generated using transmission power information monitored from a transmitter;
extracting transmission symbols at each antenna of the transmitter by space-time-decoding the RF-processed symbols;
estimating power of the respective extracted symbols; and
transmitting feedback information of the respective symbols to the transmitter.

8. The power control method according to claim 7, wherein the feedback information (W) is an average received SNR at each subcarrier and is calculated using a following equation and transmitted to the transmitter
$$W = \frac{S}{N} ( i , k ) = \frac{{E}_{s}}{2 {N}_{0}} ( {\vert {H}_{1} ( i , k ) \vert}^{2} + {\vert {H}_{2} ( i , k ) \vert}^{2} )$$
where Hⱼ(i,k) represents a channel gain experienced at a k^{th} subcarrier of an i^{th} transmit antenna for a j^{th} user, and N₀ represents a noise power density.

9. A power control system of a communication system using a space-time transmit diversity scheme, comprising:
a transmission power calculator for updating transmission power information using feedback information received from a receiver and adjusting the updated transmission power information;
a transmission power monitor for monitoring the adjusted transmission power information;
a space-time encoder newly generated for performing a space-time encoding by concatenating the monitored transmission power information and symbols to be transmitted; and
an RF processor for RF-processing the encoded symbols.

10. The power control system according to claim 9, wherein when the transmission power information exists after an initial monitoring, the space-time encoder is newly generated using a following equation
$$\begin{matrix}{\overline{X}}_{n} = [ \begin{matrix}{X}_{n} & \overline{W}\end{matrix} ] \\ = [ \begin{matrix}1 & … & 0 & {W}_{1}^{0} \\ ⋮ & ⋱ & ⋮ & ⋮ \\ 0 & ⋱ & 1 & {W}_{1}^{N - 1} \\ 0 & … & 1 & {W}_{1}^{N}\end{matrix} ] [ \begin{matrix}{X}_{n} ( 0 ) \\ ⋮ \\ {X}_{n} ( {N}_{c} - 1 ) \\ {X}_{n} ( {N}_{c} )\end{matrix} ] [ \begin{matrix}{X}_{n} ( 0 ) + {W}_{1}^{0} {X}_{n} ( {N}_{c} ) \\ {X}_{n} ( 1 ) + {W}_{1}^{1} {X}_{n} ( {N}_{c} ) \\ ⋮ \\ {X}_{n} ( {N}_{c} - 1 ) + {W}_{1}^{N} {X}_{n} ( {N}_{c} )\end{matrix} ]\end{matrix}$$
where
W̅
represents the monitored transmission power information, Xn represents the symbols to be transmitted, and Nc represents number of subcarriers.

11. The power control system according to claim 9, wherein the RF-processor transmits the RF-processed symbols using a following equation
$$\frac{{E}_{s}}{2} [ \begin{matrix}{A}_{n}^{1} & {A}_{n}^{2} \\ {A}_{n + 1}^{1} & {A}_{n + 1}^{2}\end{matrix} ] = \frac{{E}_{s}}{2} [ \begin{matrix}{{X}^{ \_}}_{n} & {{X}^{ \_}}_{n + 1} \\ - {\overline{X}}_{n + 1}^{*} & {\overline{X}}_{n}^{*}\end{matrix} ]$$
where Es represents a transmission energy per symbol in each subcarrier, Aₙⁱ represents a transmission of an n^{th} OFDM symbol at an i^{th} transmission antenna, and * represents a conjugate.

12. The power control system according to claim 9, wherein the transmission power calculator compares a received SIR and a required SIR and adjusts the transmission power information according to the comparison result.

13. A power control system of a communication system using a space-time transmit diversity scheme, comprising:
an RF processor for RF-processing symbols encoded by a space-time encoder, the space-time encoder being newly generated using transmission power information monitored from a transmitter, and estimating reception power and interference of the respective symbols extracted at respective antennas of the transmitter;
a space-time decoder for extracting transmission symbols at the respective antennas of the transmitter by space-time decoding the RF-processed symbols;
a channel estimator for detecting channel information corresponding to the respective antennas; and
a feedback channel for transmitting feedback information corresponding to the respective symbols to the transmitter.

14. The power control system according to claim 13, wherein the feedback information comprises an average SNR calculated at each subcarrier using a following equation
$$W = \frac{S}{N} ( i , k ) = \frac{{E}_{s}}{2 {N}_{0}} ( {\vert {H}_{1} ( i , k ) \vert}^{2} + {\vert {H}_{2} ( i , k ) \vert}^{2} )$$
where Hⱼ(i,k) represents a channel gain experienced at a k^{th} subcarrier of an i^{th} transmit antenna for a j^{th} user, and N₀ represents a noise power density.

15. The power control system according to claim 13, wherein the communication system is based on a WCDMA scheme, the channel estimator calculates channel estimation values by concatenating reception channels (CPICH, S-CCPCH) and data channel (DPCH).
